(19) United States
(12) Patent Application Publication
(10) Pub. No.: US 2009/0301752 A1
(43) Pub. Date: Dec. 10, 2009

(54) ETHYLENE/TETRAFLUOROETHYLENE COPOLYMER AND METHOD FOR ITS PRODUCTION

(75) Inventors: Shigeru Aida, Chiyoda-ku (JP); Yoshiaki Iwakura, Chiyoda-ku (JP); Toshiyuki Chisaka, Chiyoda-ku (JP); Hiroki Kamiya, Chiyoda-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Chiyoda-ku (JP)

(21) Appl. No.: 12/477,950

(22) Filed: Jun. 4, 2009

Related U.S. Application Data
(63) Continuation of application No. PCT/JP2007/073607, filed on Dec. 6, 2007.

(30) Foreign Application Priority Data
Dec. 8, 2006 (JP) 2006-332642

(51) Int. Cl. H01B 3/30; C08F 14/18; B32B 1/08; B32B 1/00

(52) U.S. Cl. 174/110 SR; 526/255; 428/36.9; 428/35.7

(57) ABSTRACT

To provide an ethylene/tetrafluoroethylene copolymer excellent in the thermal resistance, and a method for its production.

The ethylene/tetrafluoroethylene copolymer is produced by polymerizing ethylene with tetrafluoroethylene in an organic solvent containing no chlorine atoms as a polymerization medium, in the presence of a chain transfer agent containing no chlorine atoms and a polymerization initiator containing no chlorine atoms, and further in the substantial absence of a chain transferable compound having a carbon-chlorine atomic bond in the reaction system.

### TECHNICAL FIELD

The present invention relates to an ethylene/tetrafluoroethylene copolymer and a method for its production, and a molded product thereof.

### BACKGROUND ART

An ethylene/tetrafluoroethylene copolymer (hereinafter referred to as ETFE) is excellent in heat resistance, chemical resistance, electrical insulation properties, flame retardancy, weather resistance and mold processability, and is used as an insulating covering material for cable to be used for airplanes, nuclear power plants, automobiles or industrial robots.

Heretofore, ETFE was efficiently produced by a method for polymerizing monomers such as ethylene, tetrafluoroethylene, etc. in the presence of at least one member selected from the group consisting of a polymerization medium containing chlorine atoms, a chain transfer agent containing chlorine atoms and a polymerization initiator containing chlorine atoms.

However, if a cable using, as an insulation cover material, ETFE obtained by such a production method was maintained at a high temperature in a state where the cable was bent, cracking was problematically formed. In order to solve such a problem, a method for efficiently producing ETFE excellent in heat-resistance has been proposed (see Patent Document 1). However, such a method is still insufficient, and a method for producing ETFE having higher heat-resistance has been desired.

Further, in a process for producing a semiconductor, there is a case where a product is defective due to inclusion of chlorine atoms, and a process-constituent material not containing chlorine atoms as far as possible has been desired.

Patent Document 1: Japanese Patent No. 3,305,400

### DISCLOSURE OF THE INVENTION

### Object to be Accomplished by the Invention

It is an object of the present invention to provide ETFE excellent in heat-resistance having a remarkably small chlorine atom content, and a method for its production, which have been desired to be developed on the basis of the above background.

### Means to Accomplish Object

The present inventors have conducted extensive studies under the above circumstances, and as a result, have found that, contrary to our expectation that chain transfer is sacrificed at the time of polymerization, it is possible to produce ETFE excellent in heat-resistance by polymerization of ethylene with tetrafluoroethylene in an organic solvent containing no chlorine atoms as a polymerization medium, in the presence of a chain transfer agent containing no chlorine atoms and a polymerization initiator containing no chlorine atoms, and further in the substantial absence of a chain transferable compound having a carbon-chlorine atomic bond in the reaction system, and further the reason for excellent heat resistance is due to the low content of chlorine atoms in the obtained ETFE. The present invention has been accomplished on the basis of these discoveries.

That is, the present invention provides ETFE having the following construction and a production method thereof.
(1) ETFE which has a chlorine atom content of at most 70 ppm and a copolymerization ratio (molar ratio) of polymerized units based on tetrafluoroethylene/polymerized units based on ethylene being from 40/60 to 70/30, and which contains polymerized units based on another copolymerizable monomer, as an optional component, in an amount of from 0.1 to 10 mol % based on the total polymerized units, and has a volume flow rate (hereinafter, referred to as “value Q”) of from 0.01 to 1,000 mm³/sec.
(2) ETFE according to the above (1), which has a melting point of from 150 to 280° C.
(3) A method for producing ETFE, which comprises polymerizing ethylene with tetrafluoroethylene in an organic solvent containing no chlorine atoms as a polymerization medium, in the presence of a chain transfer agent containing no chlorine atoms and a polymerization initiator containing no chlorine atoms, and further in the substantial absence of a chain transferable compound having a carbon-chlorine atomic bond in the reaction system.
(4) The method for producing ETFE according to the above (3), wherein the organic solvent containing no chlorine atoms as a polymerization medium is CF₃(CF₂)₅H, and the chain transfer agent containing no chlorine atoms is methanol.
(5) The method for producing ETFE, according to the above (3) or (4), wherein the polymerization initiator containing no chlorine atoms is an organic peroxide having a ten hour half-life temperature of from 20 to 60° C.
(6) A molded product of ETFE produced by the production method as defined in any one of the above (3) to (5).
(7) The molded product of ETFE according to the above (6), which is a wire, a tube, a film, a sheet, a bottle or a lining.
(8) A cable obtained by covering a core wire having a diameter of 1.8 mm with the ethylene/tetrafluoroethylene copolymer as defined in the above (1) or (2), in a thickness of 0.5 mm, which is free from cracking when said cable is fixed as wound 8 times or more on the cable itself and left in an oven heated to 232° C. for at least 500 hours.
(9) A cable obtained by covering a core wire having a diameter of 1.8 mm with the ethylene/tetrafluoroethylene copolymer produced by the production method as defined in any one of the above (3) to (5), in a thickness of 0.5 mm, which is free from cracking when said cable is fixed as wound 8 times or more on the cable itself and left in an oven heated to 232° C. for at least 500 hours.

### EFFECTS OF THE INVENTION

ETFE of the present invention and ETFE produced by the production method of the present invention, are excellent in heat resistance, and a cable covered with the ETFE, to be used at a high temperature, is unlikely to undergo cracking even when the cable is bent. And even when such ETFE is used as a member for a production process of a semiconductor, the process is not adversely influenced.

### BEST MODE FOR CARRYING OUT THE INVENTION

ETFE of the present invention is a copolymer having polymerized units based on ethylene and polymerized units based on tetrafluoroethylene, and may further contain polymerized units based on another copolymerizable monomer, as optional components.

Such another copolymerizable monomer is not particularly limited so long as it contains no chlorine atoms, but may, for example, be vinyl fluoride, vinylidene fluoride, trifluoroethylene, hexafluoropropylene, CF₂=CFORf¹ (wherein, Rf¹ is a C₁₋₁₀ perfluoroalkyl group which may contain an etheric oxygen atom), CF₂=CFORf²SO₂X¹ (wherein, Rf² is a C₁₋₁₀ perfluoroalkylene group which may contain an etheric oxygen atom, and X¹ is a halogen atom other than a chlorine atom or a hydroxyl group), CF₂=CFORf²CO₂X² (wherein, Rf² is the same as the above, and X² is a hydrogen atom or a C₁₋₃ alkyl group), CF₂=CF(CF₂)ₚOCF=CF₂ (wherein, p is 1 or 2), CH₂=CX³(CF₂)_{q}X⁴ (wherein each of X³ and X⁴ which are independent of each other, is a hydrogen atom or a fluorine atom, and q is an integer of from 2 to 10), a fluorine-containing cyclic monomer such as perfluoro(2-methylene-4-methyl-1,3-dioxolane), perfluoro(2,2-dimethyl-1,3-dioxol) or perfluoro(4-methoxy-1,3-dioxol), a C₂₋₄ olefin such as propylene or isobutene, a vinyl ester such as vinyl acetate, or a vinyl ether such as ethyl vinyl ether or cyclohexyl vinyl ether. Such another copolymerizable monomer may be used alone or in combination as a mixture of two or more of them.
CF₂=CFORf¹ may, for example, be CF₂=CFOCF₃, CF₂=CFOCF₂CF₃, CF₂=CFOCF₂CF₂CF₃, CF₂=CFOCF₂CF₂CF₂CF₃ or CF₂=CFO(CF₂)₈F, preferably CF₂=CFOCF₂CF₂CF₃.
CH₂=CX³(CF₂)_{q}X⁴ may, for example, be CH₂=CH(CF₂)₂F, CH₂=CH(CF₂)₃F, CH₂=CH(CF₂)₄F, CH₂=CF(CF₂)₃H or CH₂=CF(CF₂)₄H, preferably CH₂=CH(CF₂)₂F or CH₂=CH(CF₂)₄F.

The ratio (molar ratio) of polymerized units based on tetrafluoroethylene/polymerized units based on ethylene is within a range of from 40/60 to 70/30, preferably from 50/50 to 65/35, more preferably from 51/49 to 60/40.

Further, the polymerized units based on another copolymerizable monomer, as an optional component, are contained in an amount of preferably from 0.1 to 10 mol %, more preferably from 0.3 to 8 mol %, most preferably from 0.5 to 5 mol %, based on the total polymerized units.

The ethylene/tetrafluoroethylene copolymer of the present invention contains substantially no chlorine atoms, and such a chlorine atom content is at most 70 ppm, preferably at most 60 ppm, more preferably at most 55 ppm, most preferably at most 50 ppm, based on the mass of the ethylene/tetrafluoroethylene copolymer.

It is possible to produce ETFE of the present invention by polymerizing ethylene with tetrafluoroethylene in an organic solvent containing no chlorine atoms as a polymerization medium, in the presence of a chain transfer agent containing no chlorine atoms and a polymerization initiator containing no chlorine atoms, and further in the substantial absence of a chain transferable compound having a carbon-chlorine atomic bond in the reaction system.

The polymerization medium containing no chlorine atoms, which is to be used in the present invention, is preferably a perfluorocarbon such as n-perfluorohexane, n-perfluoroheptane, perfluorocyclobutane, perfluorocyclohexane or perfluorobenzene, a hydrofluorocarbon such as 1,1,2,2-tetrafluorocyclobutane, CF₃CFHCF₂CF₂CF₃, CF₃(CF₂)₄H, CF₃CF₂CFHCF₂CF₃, CF₃CFHCFHCF₂CF₃, CF₂HCFHCF₂CF₂CF₃, CF₃(CF₂)₅H, CF₃CH(CF₃)CF₂CF₂CF₃, CF₃CF(CF₃)CFHCF₂CF₃, CF₃CF(CF₃)CFHCFHCF₃, CF₃CH(CF₃)CFHCF₂CF₃, CF₃CF₂CH₂CH₃ or CF₃(CF₂)₃CH₂CH₃, or a hydrofluoroether such as CF₃CH₂OCF₂CF₂H, CF₃(CF₃)CFCF₂OCH₃ or CF₃(CF₂)₃OCH₃, more preferably CF₃(CF₂)₅H or CF₃CH₂OCF₂CF₂H, most preferably CF₃(CF₂)₅H.

The chain transfer agent containing no chlorine atoms, to be used in the present invention, may preferably be an alcohol such as methanol, ethanol, 2,2,2-trifluoroethanol, 2,2,3,3-tetrafluoropropanol, 1,1,1,3,3,3,-hexafluoroisopropanol, 2,2,3,3,3-pentafluoropropanol, a hydrocarbon such as n-pentane, n-hexane or cyclohexane, a hydrofluorocarbon such as CF₂H₂, a ketone such as acetone, a mercaptan such as methyl mercaptan, an ester such as methyl acetate or ethyl acetate, an ether such as diethyl ether or methyl ethyl ether.

Among them, more preferred is an alcohol such as methanol, ethanol, 2,2,2-trifluoroethanol, 2,2,3,3-tetrafluoropropanol, 1,1,1,3,3,3-hexafluoroisopropanol or 2,2,3,3,3-pentafluoropropanol, most preferred is methanol.

The amount of the chain transfer agent containing no chlorine atoms is preferably from 0.01 to 50 mass %, more preferably from 0.02 to 40 mass %, most preferably from 0.05 to 20 mass %, based on the total weight of the polymerization solvent and the chain transfer agent.

The polymerization initiator containing no chlorine atoms, to be used in the present invention, is preferably a radical polymerization initiator containing no chlorine atoms, of which the temperature having a ten hour half-life (hereinafter referred to also as “a ten hour half-life temperature”) is from 0 to 100° C., more preferably from 20 to 90° C., particularly preferably from 20 to 60° C. A specific example of the polymerization initiator containing no chlorine atoms may be an azo compound such as azobisisobutyronitrile, a peroxydicarbonate such as diisopropyl peroxydicarbonate, a peroxyester such as tert-butyl peroxypivalate, tert-butyl peroxyisobutylate or tert-butyl peroxyacetate, a non-fluorine type diacyl peroxide such as isobutyryl peroxide, octanoyl peroxide, benzoyl peroxide or lauroyl peroxide, a fluorine-containing diacyl peroxide such as (Z(CF₂)ₚCOO)₂ (wherein Z is a hydrogen atom, a fluorine atom or a chlorine atom, and p is an integer of from 1 to 10), perfluoro tert-butyl peroxide, or an inorganic peroxide such as potassium persulfate, sodium persulfate or ammonium persulfate.

In the production method of ETFE of the present invention, polymerization is carried out in the substantial absence of a chain transferable compound having a carbon-chlorine atomic bond in the reaction system. Here, the substantial absence is such that the chain transferable compound is present in an amount of preferably at most 100 ppm, more preferably at most 80 ppm, furthermore preferably at most 60 ppm, most preferably at most 50 ppm, based on the total mass of the polymerization medium, the chain transfer agent containing no chlorine atoms and the polymerization initiator containing no chlorine atoms.

ETFE of the present invention has a volume flow rate (hereinafter referred to as a Q value) of from 0.01 to 1,000 mm³/sec, preferably from 0.1 to 500 mm³/sec, more preferably from 1 to 200 mm³/sec. The Q value is an index representing the melt flow property of a fluorocopolymer, and is an indicator of the molecular weight. When the Q value is high, the molecular weight becomes low, and when the Q value is low, the molecular weight becomes high. The Q value is an extrusion velocity of the fluorocopolymer at the time when the copolymer is extruded into an orifice having a diameter of 2.1 mm and a length of 8 mm under a load of 7 kg at a temperature higher by 50° C. than the melting point of the resin by using a flow tester manufactured by Shimadzu Corporation. When the Q value is within such a range, the fluorocopolymer is excellent in extrusion processability and mechanical strength.

The melting point of ETFE of the present invention is preferably from 150 to 280° C., more preferably from 180 to 275° C., most preferably from 230 to 270° C.

The production method of ETFE of the present invention may be a method of e.g. suspension polymerization, solution polymerization, emulsion polymerization or bulk polymerization, and suspension polymerization or solution polymerization is more preferred.

The polymerization conditions in the present invention are not particularly limited, but the polymerization temperature is preferably from 0 to 100° C., more preferably from 20 to 90° C. The polymerization pressure is preferably from 0.1 to 10 MPa, more preferably from 0.5 to 3 MPa. The polymerization time is preferably from 1 to 30 hours, more preferably from 2 to 20 hours.

The ethylene/tetrafluoroethylene copolymer of the present invention is free from cracking even when stress due to bending is applied thereon at a high temperature in such a case where a cable is molded with the copolymer (hereinafter, stress cracking at a high temperature may be referred to also as stress cracking).

### EXAMPLES

Now, the present invention will be described with reference to Examples and Comparative Examples, but the present invention is by no means restricted thereto. Further, methods for measuring physical properties of ETFE in Examples and Comparative Examples are shown as follows.

### Copolymer Composition of ETFE

The copolymer composition of ETFE was measured by means of FT-IR. Volume flow rate: Q value (mm³/sec)

The Q value is represented by an extrusion velocity at the time of extruding ETFE from an orifice having a diameter of 2.1 mm and a length of 8 mm at a temperature of 297° C. under a load of 7 kg by using a flow tester manufactured by Shimadzu Corporation.

### Melting Point (° C.)

The melting point was obtained from an endothermic peak at the time of heating ETFE to 300° C. at 10° C./min in the air atmosphere by using a scanning differential thermal analyzer (DSC220CU, manufactured by SII NanoTechnology Inc.).

Chlorine Atom Content (ppm)

By using an automated combustion gas trapping device AQF-100 (manufactured by Dia Instruments Co., Ltd.), 50 mg of ETFE was combusted at 1,000° C., and a decomposed gas was trapped by 25 mL of a trap liquid. Then, the trap liquid having the decomposed gas trapped therein was analyzed with an ion chromatography DX-500 (detector: conductivity detector, column: lonpac AG11H+AS11H, manufactured by Dionex Corporation) to quantify chlorine atoms.

### Stress Crack Resistance Test

A cable obtained by covering a core wire having a diameter of 1.8 mm with ETFE in a thickness of 0.5 mm, was fixed as wound 8 times or more on the cable itself and left in an oven heated to 232° C. to confirm occurrence of cracking with time. Five cables were evaluated for every lot. It is regarded as evidence of remarkably excellent stress crack resistance that a covered portion of the cable is free from cracking after expiration of at least 500 hours.

### Example 1

Into an evacuated 430 L stainless-steel autoclave, 418.2 kg of CF₃(CF₂)₅H, 2.12 kg of (perfluorobutyl)ethylene and 3.4 kg of methanol were charged and heated to 66° C. with stirring, a mixed gas of tetrafluoroethylene/ethylene=84/16 (mol %) was introduced thereto so as to be 1.5 MPaG, and a solution obtained by mixing 26g of a 50 wt % CF₃(CF₂)₅H solution of tert-butyl peroxypivalate and 4,974 g of CF₃(CF₂)₅H was injected thereto to initiate the polymerization. A mixed gas of tetrafluoroethylene/ethylene=54/46 (mol %) and (perfluorobutyl)ethylene in an amount corresponding to 1.4 mol % to the above mixed gas were continuously charged thereto so that the pressure would be 1.5 MPaG during the polymerization. After 34 kg of such a tetrafluoroethylene/ethylene mixed gas was charged, the autoclave was cooled, and a residual gas was purged to terminate polymerization.

An ETFE slurry obtained was put into a 850 L granulation tank, and 340 L of water was added thereto, followed by heating with stirring, to remove the solvent for polymerization and residual monomers thereby to obtain 35 kg of granulary ETFE1.

ETFE1 obtained had a composition of polymerized units based on tetrafluoroethylene/polymerized units based on ethylene/polymerized units based on (perfluorobutyl)ethylene=54.2/44.1/1.7 mol %, a chlorine atom content being 49 ppm, Q value being 44 mm³/sec and a melting point being 255° C.

Such ETFE1 was formed into pellets by using a single screw extruder, and the pellets were subjected to melt extrusion molding to form a cable having a 1.8 mm-diameter core wire covered with ETFE1 in a thickness of 0.5 mm. The stress crack resistance of the cable thus obtained was tested, whereby no cracking was observed in five samples even after expiration of 528 hours.

### Comparative Example 1

ETFE was produced in the same manner as in Example 1 except that the amount of CF₃(CF₂)₅H used was changed to 255.3 kg, the amount of (perfluorobutyl)ethylene used was changed to 2.08 kg, 158 kg of 1,3-dichloro-1,1,2,2,3-pentafluoropropane was used instead of methanol, and a solution obtained by mixing 32 g of a 50 wt % 1,3-dichloro-1,1,2,2,3-pentafluoropropane solution of tert-butyl peroxypivalate and 4,968 g of CF₃(CF₂)₅H, was used instead of the solution obtained by mixing 26 g of a 50 wt % CF₃(CF₂)₅H solution of tert-butyl peroxypivalate and 4,974 g of CF₃(CF₂)₅H, and 37 kg of granulary ETFE2 was obtained.

ETFE2 obtained had a composition of polymerized units based on tetrafluoroethylene/polymerized units based on ethylene/polymerized units based on (perfluorobutyl)ethylene32 54.4/44.2/1.4 mol %, a chlorine atom content being 599 ppm, a Q value being 40 mm³/sec and a melting point being 257° C.

Then, a cable covered with ETFE2 was formed and the stress crack resistance was tested in the same manner as in Example 1, and occurrence of cracking was confirmed at covered portions of all five cables upon expiration of 96 hours.

From the above results, ETFE1 obtained in Example 1 is found to be superior in heat resistance to ETFE2 obtained in Comparative Example 1. Further, in ETFE1 obtained in Example 1 the chlorine atom content is suppressed to a low level as compared with ETFE2 obtained in Comparative Example 1, and such an ETFE1 is suitable as a material for a semiconductor production process in which inclusion of chlorine atoms is required to be lowered to the utmost.

### INDUSTRIAL APPLICABILITY

ETFE of the present invention and ETFE obtainable by the production process of the present invention has good thermal resistance. Therefore, they are useful for various applications, e.g. for wires, tubes, films, sheets, bottles and linings, and they are particularly suitable for a cable covering material to be used at a high temperature or a material to be used for a semiconductor production process.

The entire disclosure of Japanese Patent Application No. 2006-332642 filed on Dec. 8, 2006 including specification, claims, drawings and summary is incorporated herein by reference in its entirety.

What is claimed is:

1. An ethylene/tetrafluoroethylene copolymer which has a chlorine atom content of at most 70 ppm and a copolymerization ratio (molar ratio) of polymerized units based on tetrafluoroethylene/polymerized units based on ethylene being from 40/60 to 70/30, and which contains polymerized units based on another copolymerizable monomer, as an optional component, in an amount of from 0.1 to 10 mol % based on the total polymerized units, and has a volume flow rate of from 0.01 to 1,000 mm³/sec.

2. The ethylene/tetrafluoroethylene copolymer according to claim 1, which has a melting point of from 150 to 280° C.

3. A method for producing an ethylene/tetrafluoroethylene copolymer, which comprises polymerizing ethylene with tetrafluoroethylene in an organic solvent containing no chlorine atoms as a polymerization medium, in the presence of a chain transfer agent containing no chlorine atoms and a polymerization initiator containing no chlorine atoms, and further in the substantial absence of a chain transferable compound having a carbon-chlorine atomic bond in the reaction system.

4. The method for producing an ethylene/tetrafluoroethylene copolymer according to claim 3, wherein the organic solvent containing no chlorine atoms as a polymerization medium is CF₃(CF₂)₅H, and the chain transfer agent containing no chlorine atoms is methanol.

5. The method for producing an ethylene/tetrafluoroethylene copolymer, according to claim 3, wherein the polymerization initiator containing no chlorine atoms is an organic peroxide having a ten hour half-life temperature of from 20 to 60° C.

6. A molded product of an ethylene/tetrafluoroethylene copolymer produced by the production method as defined in claim 3.

7. The molded product of an ethylene/tetrafluoroethylene copolymer according to claim 6, which is a wire, a tube, a film, a sheet, a bottle or a lining.

8. A cable obtained by covering a core wire having a diameter of 1.8 mm with the ethylene/tetrafluoroethylene copolymer as defined in claim 1, in a thickness of 0.5 mm, which is free from cracking when said cable is fixed as wound 8 times or more on the cable itself and left in an oven heated to 232° C. for at least 500 hours.

9. A cable obtained by covering a core wire having a diameter of 1.8 mm with the ethylene/tetrafluoroethylene copolymer produced by the production method as defined in claim 3, in a thickness of 0.5 mm, which is free from cracking when said cable is fixed as wound 8 times or more on the cable itself and left in an oven heated to 232° C. for at least 500 hours.
